(19) United States
(12) Patent Application Publication
(10) Pub. No.: US 2025/0087418 A1
(43) Pub. Date: Mar. 13, 2025

(54) CAPACITOR, ELECTRIC CIRCUIT, CIRCUIT SUBSTRATE, AND DEVICE

(71) Applicant: Panasonic Intellectual Property Management Co., Ltd., Osaka (JP)

(72) Inventors: Tomoyasu YOKOYAMA, Osaka (JP); Kosei OHURA, Osaka (JP); Ryosuke KIKUCHI, Osaka (JP)

(21) Appl. No.: 18/960,876

(22) Filed: Nov. 26, 2024

Related U.S. Application Data
(63) Continuation of application No. PCT/JP2023/017189, filed on May 2, 2023.

(30) Foreign Application Priority Data
May 31, 2022 (JP) 2022-089285

(51) Int. Cl. H01G 4/08; H01G 4/40

(52) U.S. Cl. CPC H01G 4/08; H01G 4/40

(57) ABSTRACT

A capacitor includes a first electrode, a second electrode, and a dielectric. The dielectric is disposed between the first electrode and the second electrode. The dielectric includes a halide and satisfies a requirement 1/2<r<2/3. In this requirement, r is a ratio of the number of cations to the number of anions in the halide included in the dielectric.

This application is a continuation of PCT/JP2023/017189 filed on May 2, 2023,which claims foreign priority of Japanese Patent Application No. 2022-089285 filed on May 31, 2022, the entire contents of both of which are incorporated herein by reference.

### BACKGROUND OF THE INVENTION

### 1. Field of the Invention

The present invention relates to a capacitor, an electrical circuit, a circuit board, and an apparatus.

### 2. Description of Related Art

Conventionally, halides are included in devices such as perovskite solar cells. For example, JP 2016-171152 A describes a ferroelectric memory device in which a ferroelectric layer is sandwiched between a pair of electrodes. The ferroelectric layer includes a certain halide-based organic-inorganic hybrid perovskite compound or a certain inorganic perovskite compound. Examples of the halide organic-inorganic hybrid perovskite compound include CH₃NH₃Pbl₃, C₂H₅NH₃Pbl₄, CH₃NH₃Snl₃, and C₂H₅NH₃Snl₄. Examples of the inorganic perovskite compound include CsSnl₃.

JP H10-093031 A discloses a ferroelectric apparatus including a ferroelectric element including a pair of surfaces facing each other and a pair of electrodes placed on the surfaces. CsGeCl₃ and BaMgF₄ are shown as examples of the material of a body of the ferroelectric element.

### SUMMARY OF THE INVENTION

The present disclosure can provide a capacitor including a halide-including dielectric, the capacitor being advantageous in terms of a high capacitance.

A capacitor of the present disclosure includes:
a first electrode;
a second electrode; and
a dielectric disposed between the first electrode and the second electrode, wherein
the dielectric includes a halide and satisfies a requirement 1/2<r<2/3, where r is a ratio of the number of cations to the number of anions in the halide.

The present disclosure can provide a capacitor including a halide-including dielectric, the capacitor being advantageous in terms of a high capacitance.

### BRIEF DESCRIPTION OF THE DRAWINGS

FIG. 1 is a cross-sectional view showing an example of a capacitor of the present disclosure.

FIG. 2 is a graph showing relations between calculation values of relative permittivities of PbS compounds having different coordination polyhedra and volumes of the coordination polyhedra.

FIG. 3A shows a coordination polyhedron of a ZnS-type crystal structure.

FIG. 3B shows a coordination polyhedron of a NaCl-type crystal structure.

FIG. 3C shows a coordination polyhedron of a CuS-type crystal structure.

FIG. 4A is a cross-sectional view showing another example of the capacitor of the present disclosure.

FIG. 4B is a cross-sectional view showing yet another example of the capacitor of the present disclosure.

FIG. 4C is a cross-sectional view showing yet another example of the capacitor of the present disclosure.

FIG. 5A schematically shows an example of an electrical circuit of the present disclosure.

FIG. 5B schematically shows an example of a circuit board of the present disclosure.

FIG. 5C schematically shows an example of an apparatus of the present disclosure.

FIG. 6 schematically shows a method for evaluating relative permittivities of dielectrics according to Examples and Comparative Examples.

FIG. 7 is a graph showing an X-ray diffraction (XRD) pattern of a dielectric according to Example 1.

FIG. 8 is a graph showing an XRD pattern of a dielectric according to Comparative Example 2.

FIG. 9 shows a perovskite-type crystal structure of (CH3NH3) SnCl3.

FIG. 10 shows a (NH₄)P_{b}2Br₅-type crystal structure of KSn2Cl5.

### DETAILED DESCRIPTION

### (Findings on which the Present Disclosure is Based)

Size reduction, increase in integration density, and increase in operating frequency of electronic circuits have been promoted in recent years along with size reduction and advancement of functionality of electronic devices. Size reduction and performance increase are required also of electronic components to be included in electronic circuits. It is thought that, for example, provision of a small-sized capacitor having a high capacitance will be able to contribute to size reduction and performance increase of electronic components. The capacitance of a capacitor depends on the relative permittivity of a dielectric in the capacitor. The higher the relative permittivity is, the higher the capacitance becomes. Capacitors including an oxide dielectric as a dielectric having a high relative permittivity have been widely developed. However, synthesis of oxides often requires sintering at as high a temperature as 500° C. or higher, which tends to increase the capacitor manufacturing cost. Moreover, many oxides have small elastic moduli, and that makes it difficult to increase filling rates of compression-molded bodies made from oxide powders. Consequently, it is difficult to enhance the capacitor performance. Furthermore, oxides are not likely to have high strengths against bending stress.

Halides can be free of these disadvantages of oxides. Since halides are commonly highly soluble in water and organic solvents, it is easy to synthesize halides by application. Moreover, since it is possible to synthesize halides at as low a temperature as 200° C. or lower, the capacitor manufacturing cost can be reduced. In addition, it is possible to form halide films on substrates such as films having a low high-temperature durability, and that can contribute to achievement of flexible capacitors. Furthermore, since the elastic moduli of halides are generally higher than those of oxides, filling rates of compression-molded bodies made from halide powders are likely to increase. However, it may be impossible to achieve with halides as high a capacitance as with oxide dielectrics since halides have low relative permittivities at room temperature.

In view of these circumstances, the present inventors made intensive studies to find whether it is possible to develop a capacitor including a halide-including dielectric, the capacitor being advantageous to achieve a high capacitance. Through the intensive studies, the present inventors newly found that a dielectric produced such that the number of anions and the number of cations in a halide satisfy a given requirement tends to have a high relative permittivity. On the basis of this new finding, the present inventors have devised a capacitor of the present disclosure.

### (Summary of one Aspect According to the Present Disclosure)

A capacitor according to a first aspect of the present disclosure includes:
a first electrode;
a second electrode; and
a dielectric disposed between the first electrode and the second electrode, wherein
the dielectric includes a halide and satisfies a requirement 1/2<r<2/3, where r is a ratio of the number of cations to the number of anions in the halide.

According to the first aspect, it is likely that the coordination number of the anion around the cation is large and the dielectric has a high relative permittivity. Hence, the capacitor is likely to have a high capacitance.

According to a second aspect of the present disclosure, for example, in the capacitor according to the first aspect, the dielectric may satisfy a requirement 0.57≤r ≤0.61. According to the second aspect, it is more likely that the dielectric has a high relative permittivity and the capacitor has a high capacitance.

According to a third aspect of the present disclosure, for example, in the capacitor according to the first or second aspect, the cation may include an ion of an element in at least one group selected from the group consisting of Group 13, Group 14,and Group 15. According to the third aspect, it is more likely that the dielectric has a high relative permittivity and the capacitor has a high capacitance.

According to a fourth aspect of the present disclosure, for example, in the capacitor according to the third aspect, the cation may have a lone pair. According to the fourth aspect, the electrons forming the lone pair are less likely to be bonded to a nearby ion. This is likely to make an electronic state of the cation unstable and allow the dielectric to have a desired crystal structure. Hence, it is more likely that the dielectric has a high relative permittivity and the capacitor has a high capacitance.

According to a fifth aspect of the present disclosure, for example, in the capacitor according to any one of the first to fourth aspects, the cation may include at least one selected from the group consisting of In⁺, TI⁺, Ge²⁺, Sn²⁺, Pb²⁺, Sb³⁺, and Bi³⁺. According to the fifth aspect, it is more likely that the dielectric has a high relative permittivity and the capacitor has a high capacitance.

According to a sixth aspect of the present disclosure, for example, in the capacitor according to any one of the first to fifth aspects, the cation may include at least one selected from the group consisting of Li⁺, Na⁺, K⁺, Rb⁺, Cs⁺, In⁺, and Tl⁺. According to the sixth aspect, it is more likely that the dielectric has a high relative permittivity and the capacitor has a high capacitance.

According to a seventh aspect of the present disclosure, for example, in the capacitor according to any one of the first to sixth aspects, the dielectric may have a composition represented by AB₂X₅. In the composition, A may be at least one selected from the group consisting of Li⁺, Na⁺, K⁺, Rb⁺, Cs⁺, In⁺, and Tl⁺. The symbol B may be at least one selected from the group consisting of Sn²⁺and Pb²⁺. The symbol X may be at least one selected from the group consisting of F⁻, Cl⁻, Br⁻, I⁻, and SCN⁻. According to the seventh aspect, it is more likely that the dielectric has a high relative permittivity and the capacitor has a high capacitance.

According to an eighth aspect of the present disclosure, for example, in the capacitor according to first to seventh aspects, the anion may be at least one selected from the group consisting of F⁻ and CI⁻. According to the eighth aspect, it is likely that the dielectric has a large breakdown electric field and the capacitor has a high voltage resistance.

An electrical circuit according to a ninth aspect of the present disclosure includes the capacitor according to any one of the first to eighth aspects. According to the ninth aspect, it is likely that the capacitor has a high capacitance and the electrical circuit exhibits a desired performance.

A circuit board according to a tenth aspect of the present disclosure includes the capacitor according to any one of the first to eighth aspects. According to the tenth aspect, it is likely that the capacitor has a high capacitance and the circuit board exhibits a desired performance.

An apparatus according to an eleventh aspect of the present disclosure includes the capacitor according to any one of the first to eighth aspects. According to the eleventh aspect, it is likely that the capacitor has a high capacitance and the apparatus exhibits a desired performance.

### (Embodiments)

Embodiments of the present disclosure will be described hereinafter with reference to the drawings. The present disclosure is not limited to the following embodiments.

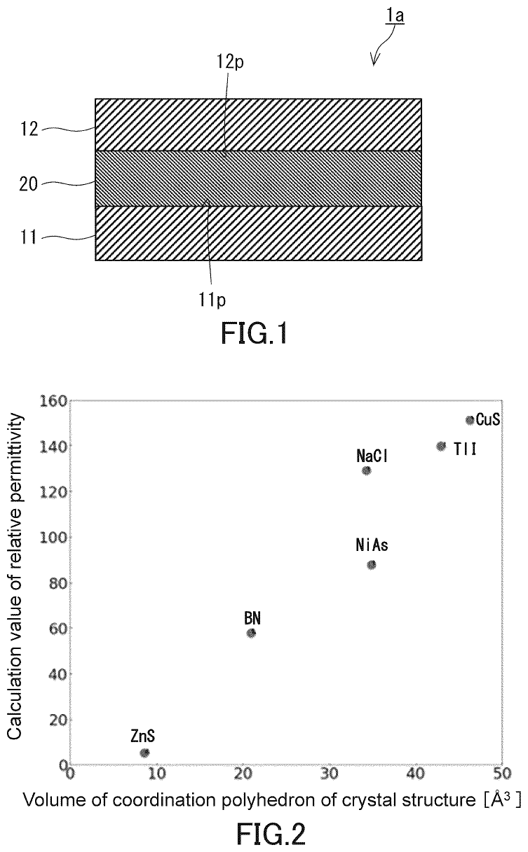

FIG. 1 is a cross-sectional view showing an example of the capacitor of the present disclosure. As shown in FIG. 1, a capacitor 1a includes a first electrode 11, a second electrode 12, and a dielectric 20. The dielectric 20 is disposed between the first electrode 11 and the second electrode 12. The dielectric 20 includes a halide and satisfies a requirement 1/2<r<2/3. In this requirement, r is a ratio of the number of cations to the number of anions in the halide. The dielectric 20 includes, for example, an ionic crystal.

FIG. 2 is a graph showing relations between calculation values of relative permittivities of PbS compounds having different coordination polyhedra and volumes of the coordination polyhedra. The calculation values of the relative permittivities of these

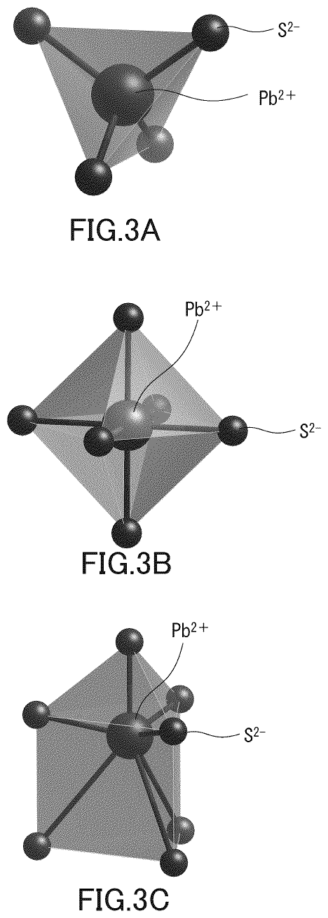

PbS compounds are obtained by first-principles calculation. Plot markers in the graph of FIG. 2 represent compounds corresponding to crystal structures used as prototypes in the first-principles calculation. In FIG. 2, ZnS is zinc sulfide, BN is boron nitride, NiAs is nickel arsenide, NaCl is sodium chloride, TII is thallium iodide, and CuS is copper (II) sulfide. FIG. 3A shows a coordination polyhedron of a ZnS-type crystal structure, FIG. 3B shows a coordination polyhedron of a NaCl-type crystal structure, and FIG. 3C shows a coordination polyhedron of a CuS-type crystal structure. As shown in FIG. 3A, in the ZnS-type crystal structure, S2-is coordinated to form a tetrahedron (four-coordinate) having Pb²⁺ at its center. As shown in FIG. 3B, in the NaCl-type crystal structure, S²⁻ is coordinated to form an octahedron (six-coordinate) having Pb²⁺ at its center. As shown in FIG. 3C, in the CuS-type crystal structure, S2²⁻ is coordinated to form a triangular pyramid (seven-coordinate) having Pb²⁺ at its center. It is understood from FIG. 2 that a coordination polyhedron having a larger coordination number has a larger volume. This fact suggests that in FIG. 2, the larger the coordination number of the anion S²⁻ around the cation Pb²⁺ is, the higher the relative permittivity of PbS can be. This is presumably because a coordination polyhedron having a large coordination number has a large volume, allowing an ion to move in a large area to increase local polarization.

Furthermore, the coordination number of an anion around a cation can more greatly affect the relative permittivity than the coordination number of the cation around the anion. The reason is that a cation has a larger absolute value of the valence than an anion and thus tends to cause larger polarization. For example, in TiO₂, an anion 0²⁻ is negative divalent, while a cation Ti⁴⁺ is positive tetravalent. Therefore, it is thought that a material having a crystal structure in which the coordination number of an anion around a cation is large has a high relative permittivity. A composition in which the ratio of the number of cations to the number of anions in the halide included in the dielectric is small is advantageous to achieve a structure in which the coordination number of the anion around the cation is large.

Since the dielectric 20 satisfies the requirement r<2/3, the ratio of the number of cations to the number of anions is small in the halide included in the dielectric 20. Hence, the coordination number of the anion around the cation is likely to be large, and the dielectric 20 is likely to have a high relative permittivity. Consequently, the capacitor 1a is likely to have a high capacitance. Moreover, since the dielectric 20 satisfies the requirement 1/2<r, it is likely that the dielectric 20 has a local structure having a high coordination number, a desired crystal structure is formed, and the dielectric 20 has a high relative permittivity.

The dielectric 20 may satisfy a requirement r≤0.66, r≤0.65, r≤0.64, orr≤0.63. The dielectric 20 may satisfy a requirement r≤0.62, r≤0.61, or r≤0.60.

The dielectric 20 may satisfy a requirement 0.51≤r, 0.52≤r, 0.53≤r, or 0.54≤r. The dielectric 20 may satisfy a requirement 0.55≤r, 0.56≤r, or 0.57≤r.

The dielectric 20 desirably satisfies a requirement 0.57≤r≤0.61. In this case, it is more likely that the dielectric 20 has a high relative permittivity and the capacitor 1a has a high capacitance.

The cation in the dielectric 20 is not limited to a particular cation. The cation includes, for example, an ion of an element in at least one group selected from the group consisting of Group 13, Group 14, and Group 15. In this case, it is more likely that the dielectric 20 has a high relative permittivity and the capacitor 1a has a high capacitance.

The cation in the dielectric 20 has, for example, a lone pair. The lone pair is an electron pair formed of paired electrons that belong to a given atom and that are not shared with another atom. For example, Sn²⁺, which is an ion of Sn being an element of Group 14, has a lone pair. Sn2+is formed by stripping Sn of two electrons, and two electrons of Sn²⁺ in the s orbital in the outermost shell form a lone pair. The electrons forming a lone pair are not likely to be bonded to a nearby ion, and can contribute to an unstable electronic state or a special crystal structure. Therefore, when the cation in the dielectric 20 has a lone pair, the dielectric 20 is likely to have a high relative permittivity. Meanwhile, Sn⁴⁺ is a Sn ion, as is Sn²⁺. Sn⁴⁺ is formed by stripping Sn of four electrons, and thus the s orbital in the outermost shell is empty. Therefore, Sn⁴⁺ has no lone pair. In this case, a crystal structure having a small coordination number is likely to be formed, and the relative permittivity of the material is not likely to be high.

For example, every cation in the dielectric 20 may have a lone pair, or only portion of the cation in the dielectric 20 may have a lone pair.

The cation in the dielectric 20 includes, for example, at least one selected from the group consisting of In⁺, TI⁺, Ge²⁺, Sn²⁺, Pb²⁺, Sb³⁺, and Bi³⁺. In this case, it is more likely that the dielectric 20 has a high relative permittivity and the capacitor 1a has a high capacitance. The cation in the dielectric 20 may include only at least one selected from the group consisting of In⁺, TI⁺, Ge²⁺, Sn²⁺, Pb²⁺, Sb³⁺, and Bi³⁺, or may include a cation not in this group.

The cation in the dielectric 20 includes, for example, at least one selected from the group consisting of Li⁺, Na⁺, K⁺, Rb⁺, Cs⁺, In⁺, and Tl⁺. In this case, it is more likely that the dielectric 20 has a high relative permittivity and the capacitor 1a has a high capacitance.

The anion in the halide is not limited to a particular anion as long as the dielectric 20 includes the halide and satisfies the requirement 1/2<r<2/3. As the anion, the halide included in the dielectric 20 may include only a halogen ion, or may include an anion other than a halogen ion. The anion in the halide may be, for example, at least one selected from the group consisting of F⁻ and Cl⁻ . In this case, the dielectric 20 is likely to have a large band gap and a large breakdown electric field. Hence, the capacitor 1a is likely to have a high voltage resistance. The halide included in the dielectric 20 may include only at least one selected from the group consisting of F⁻ and Cl⁻ as the anion. In this case, the dielectric 20 is more likely to have a large band gap and a large breakdown electric field. The halide included in the dielectric 20 may include an anion other than F⁻ or C⁻ in addition to at least one selected from the group consisting of F⁻ and C⁻ .

A composition of the dielectric 20 is not limited to a particular composition as long as the dielectric 20 satisfies the requirement 1/2<r<2/3. The dielectric 20 has a composition, for example, represented by AB₂X₅. In this composition, A is at least one selected from the group consisting of Li⁺, Na⁺, K⁺, Rb⁺, Cs⁺, In⁺, and Tl⁺. The symbol B is at least one selected from the group consisting of Sn²⁺ and Pb²⁺. The symbol X is at least one selected from the group consisting of F⁻, Cl⁻, Br⁻, I⁻, and SCN⁻. When the dielectric 20 has such a composition, it is more likely that the dielectric 20 has a high relative permittivity and the capacitor 1a has a high capacitance.

Typically, in the above composition, the dielectric 20 includes at least one selected from the group consisting of F⁻, C⁻, Br⁻, and I⁻ as X.

The relative permittivity of the dielectric 20 is not limited to a particular value. The relative permittivity of the dielectric 20 at a room temperature may be, for example, more than 40, 45 or more, 50 or more, 60 or more, 80 or more, or 100 or more at 1 MHz. The room temperature is a particular temperature in the range of, for example, 20° C. to 25° C. The relative permittivity of the dielectric 20 at the room temperature is, for example, 10000 or less at 1 MHZ. In other words, the relative permittivity of the dielectric 20 at the room temperature is, for example, 40 or more and 10000 or less at 1 MHz.

As shown in FIG. 1, the dielectric 20 of the capacitor 1a is formed, for example, as a film. A method for disposing the dielectric 20 in the capacitor 1a is not limited to a particular method. The dielectric 20 may be formed, for example, by spin coating, an inkjet technique, die coating, roll coating, bar coating, Langmuir-Blodgett, dip coating, or spray coating. This makes it more likely that the dielectric 20 has a high relative permittivity and the capacitor 1a has a high capacitance. The dielectric 20 may be formed by sputtering, anodic oxidation, vacuum deposition, pulsed laser deposition

(PLD), atomic layer deposition (ALD), or chemical vapor deposition (CVD).

As shown in FIG. 1, the dielectric 20 is disposed, for example, between the first electrode 11 and the second electrode 12 in a thickness direction of the dielectric 20. The second electrode 12 covers, for example, at least a portion of the dielectric 20. Materials of the first electrode 11 and the second electrode 12 are not limited to particular materials. The first electrode 11 and the second electrode 12 each include, for example, a metal. The first electrode 11 includes, for example, a valve metal. Examples of the valve metal include Al, Ta, Nb, and Bi. The first electrode 11 includes, for example, at least one selected from the group consisting of Ta, Nb, and Bi as the valve metal. The first electrode 11 may include a noble metal such as gold or platinum, nickel, or a metal element in Group 13, Group 14, or Group 15.

The second electrode 12 may include, for example, a valve metal such as Al, Ta, Nb, or Bi, a noble metal such as gold, silver, or platinum, nickel, or a metal element in Group 13, Group 14, or Group 15. The second electrode 12 includes, for example, at least one selected from the group consisting of Al, Ta, Nb, Bi, gold, silver, platinum, and nickel.

As shown in FIG. 1, the first electrode 11 has a principal surface 11p. One principal surface of the dielectric 20 is in contact with, for example, the principal surface 11p. The second electrode 12 has a principal surface 12p parallel to the principal surface 11p. The other principal surface of the dielectric 20 is in contact with, for example, the principal surface 12p.

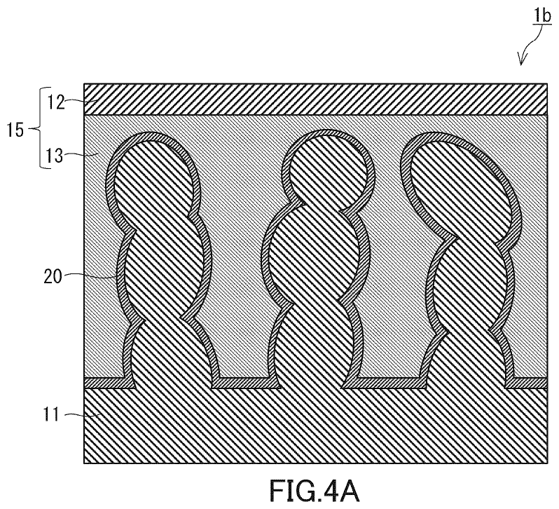

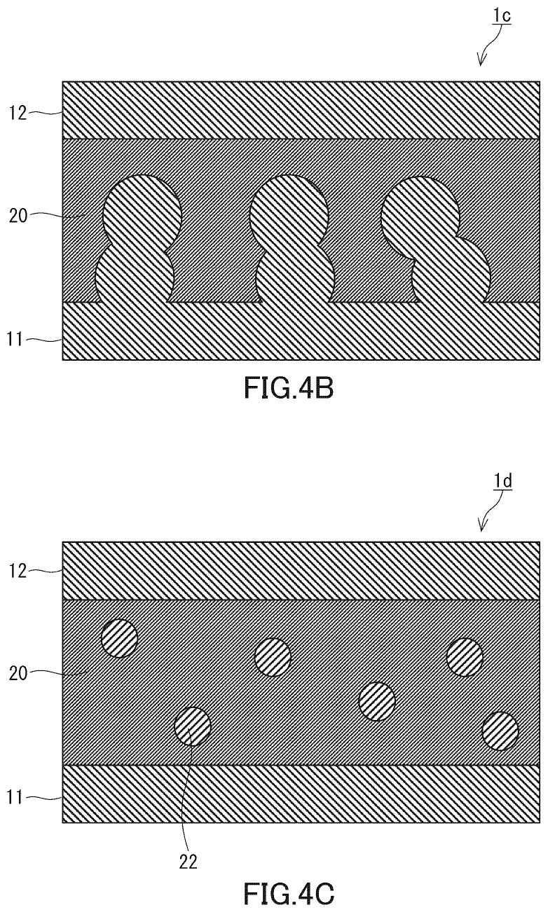

FIG. 4A is a cross-sectional view showing another example of the capacitor of the present disclosure. A capacitor 1b shown in FIG. 4A is configured in the same manner as the capacitor 1a unless otherwise described. The components of the capacitor 1b that are the same as or correspond to the components of the capacitor 1a are denoted by the same reference characters, and detailed descriptions of such components are omitted. The description given for the capacitor 1a is applicable to the capacitor 1b unless there is a technical inconsistency. The same is applicable to capacitors 1c and 1d described later.

The capacitor 1b shown in FIG. 4A is an electrolytic capacitor. As shown in FIG. 4A, at least a portion of the first electrode 11 is porous in the capacitor 1b. This makes it likely that the first electrode 11 has a large surface area and the capacitor 1b has a higher capacitance. The porous structure as described above can be formed, for example, by a method such as etching of a metallic foil or sintering of a powder.

As shown in FIG. 4A, for example, the film of the dielectric 20 is placed on a surface of the porous portion of the first electrode 11. For example, spin coating, an inkjet technique, die coating, roll coating, bar coating, Langmuir-Blodgett, dip coating, or spray coating can be adopted as the method for forming the dielectric 20. The dielectric 20 may be formed, for example, by sputtering, anodic oxidation, vacuum deposition, PLD, ALD, or CVD.

The first electrode 11 includes, for example, a valve metal such as Al, Ta, Nb, Zr, Hf, or Bi. The second electrode 12 may include, for example, a solidified body of a silver-including paste, a carbon material such as graphite, or both the solidified body and the carbon material.

In the capacitor 1b, an electrolyte 13 is disposed, for example, between the first electrode 11 and the second electrode 12. Specifically, the electrolyte 13 is disposed between the dielectric 20 and the second electrode 12. In the capacitor 1b, for example, a cathode is formed of the second electrode 12 and the electrolyte 13. In the capacitor 1b, the electrolyte 13 is disposed, for example, to fill a space around the porous portion of the first electrode 11.

The electrolyte 13 includes, for example, at least one selected from the group consisting of an electrolyte solution and an electrically conductive polymer. Examples of the electrically conductive polymer include polypyrrole, a polythiophene, polyaniline, and derivatives of these. The electrolyte 13 may be made of a manganese compound such as manganese oxide. The electrolyte 13 may include a solid electrolyte.

The electrolyte 13 including the electrically conductive polymer can be formed by performing chemical polymerization, electrolytic polymerization, or both chemical polymerization and electrolytic polymerization of a raw material monomer on the dielectric 20. The electrolyte 13 including the electrically conductive polymer may be formed by making a solution or a dispersion of the electrically conductive polymer adhere to the dielectric 20.

FIG. 4B is a cross-sectional view showing yet another example of the capacitor of the present disclosure. At least a portion of the first electrode 11 is porous in the capacitor 1c shown in FIG. 4B. This makes it likely that the first electrode 11 has a large surface area and the capacitor 1c has a higher capacitance. The porous structure as described above can be formed, for example, by a method such as etching of a metallic foil or sintering of a powder.

As shown in FIG. 4B, for example, the film of the dielectric 20 is placed on the porous portion of the first electrode 11. For example, spin coating, an inkjet technique, die coating, roll coating, bar coating, Langmuir-Blodgett, dip coating, or spray coating can be adopted as the method for forming the dielectric 20. In the capacitor 1d, the dielectric 20 is disposed, for example, to fill a space around the porous portion of the first electrode 11.

FIG. 4C is a cross-sectional view showing yet another example of the capacitor of the present disclosure. The dielectric 20 of the capacitor 1d shown in FIG. 4C is formed, for example, as a film. Particles of a dissimilar dielectric 22 different from the dielectric 20 are dispersed in this film. For example, spin coating, an inkjet technique, die coating, roll coating, bar coating, Langmuir-Blodgett, dip coating, or spray coating can be adopted as the method for forming this film. For example, the film including the dielectric 20 and the dissimilar dielectric 22 can be obtained by forming a coating film of a liquid precursor containing a raw material of the dielectric 20 and the particles of the dissimilar dielectric 22 by the above method. This film may be formed by sputtering, anodic oxidation, vacuum deposition, PLD, ALD, or CVD.

The dissimilar dielectric 22 is not limited to a particular dielectric as long as the dissimilar dielectric 22 is a different type of dielectric from the dielectric 20. The dissimilar dielectric 22 has a relative permittivity, for example, higher than that of the dielectric 20. For example, the dissimilar dielectric 22 may be made of a perovskite compound such as BaTiO₃, PbTiO₃, or SrTiO₃, or may be made of a layered perovskite compound. The dissimilar dielectric 22 may include at least one selected from the group consisting of a Ruddlesden-Popper compound, a Dion-Jacobson compound, a tungsten bronze compound, and a pyrochlore compound.

The size of the particle of the dissimilar dielectric 22 is not limited to a particular value. The size of the particle of the dissimilar dielectric 22 is, for example, 1 nm or more and 100 nm or less.

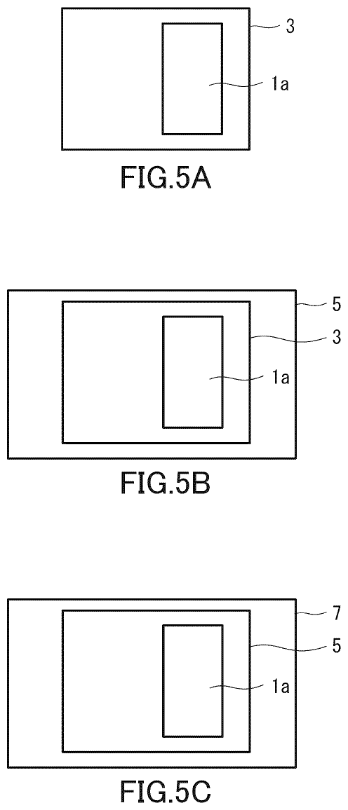

FIG. 5A schematically shows an example of an electrical circuit of the present disclosure. An electrical circuit 3 includes the capacitor 1a. The electrical circuit 3 may be an active circuit or a passive circuit. The electrical circuit 3 may be a discharging circuit, a smoothing circuit, a decoupling circuit, or a coupling circuit. Since including the capacitor 1a, the electrical circuit 3 is likely to exhibit a desired performance. For example, it is likely that the capacitor 1a reduces noise in the electrical circuit 3. The electrical circuit 3 may include the capacitor 1b, 1c, or 1d instead of the capacitor 1a.

FIG. 5B schematically shows an example of a circuit board of the present disclosure. As shown in FIG. 5B, a circuit board 5 includes the capacitor 1a. For example, the circuit board 5 includes the electrical circuit 3 including the capacitor 1a. The circuit board 5 may be an embedded board or a motherboard. The circuit board 5 may include the capacitor 1b, 1c, or 1d instead of the capacitor 1a.

FIG. 5C schematically shows an example of an apparatus of the present disclosure. As shown in FIG. 5C, an apparatus 7 includes, for example, the capacitor 1a. The apparatus 7 includes, for example, the circuit board 5 including the capacitor 1a. Since including the capacitor 1a, the apparatus 7 is likely to exhibit a desired performance. The apparatus 7 may be an electronic device, a communication device, a signal-processing device, or a power-supply device. The apparatus 7 may be a server, an AC adapter, an accelerator, or a flat-panel display such as a liquid crystal display (LCD). The apparatus 7 may be a USB charger, a solid-state drive (SSD), an information terminal such as a PC, a smartphone, or a tablet PC, or an Ethernet switch.

### EXAMPLES

Hereinafter, the present disclosure will be described in more detail with reference to examples. The examples given below are just examples, and the present disclosure is not limited to them.

### <Example 1>

### (Production of dielectric material)

A raw material powder including KCI and SnCl₂ was prepared in an argon atmosphere (hereinafter referred to as “dry argon atmosphere”) with a dew point of −60° C. such that a ratio of the amount of substance of KCl to the amount of substance of SnCl₂ was 1:2. This raw material powder was pulverized and mixed together in a mortar. A mixed powder was thus obtained. The mixed powder was milled using a planetary ball mill at 500 revolutions per minute (rpm) for 12 hours. A powdery dielectric according to Example 1 was obtained in this manner. The dielectric according to Example 1 included a halide having a composition represented by KSn₂Cl₅.

The dielectric according to Example 1 was measured by X-ray photoelectron spectroscopy (XPS) using an XPS apparatus PHI VersaProbe 2 manufactured by ULVAC PHI, INC. Amounts of K, Sn, and Cl in the dielectric per unit weight were determined from the measurement result. The amounts of K, Sn, and CI revealed that a relation between the amount of substance of K to the amount of substance of Sn to the amount of substance of Cl was 1:2:5 in the dielectric according to Example 1, as in the raw material powder.

### (Evaluation of Relative Permittivity)

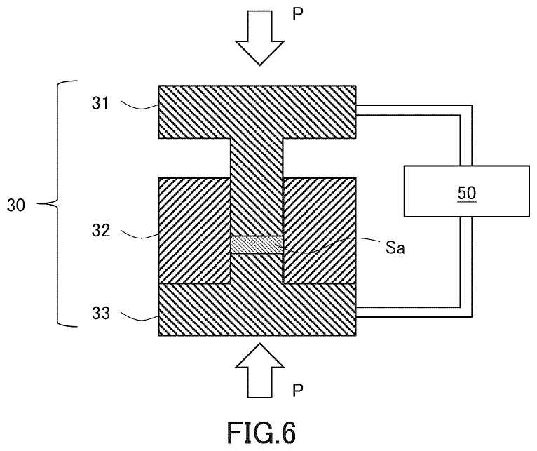

FIG. 6 schematically shows a relative permittivity evaluation method. As shown in FIG. 6, a compression molding die 30 included an upper punch 31, a die 32, and a lower punch 33. The upper punch 31 and the lower punch 33 were each made of stainless steel, which has electron conductivity. The die 32 was made of polycarbonate, which has electrical insulating properties.

A relative permittivity of the halide included in the dielectric according to Example 1 was measured by the following method using the compression molding die 30.

The compression molding die 30 was filled with the powdery dielectric according to Example 1 in a dry atmosphere with a dew point of −30° C. or lower to give a sample Sa. In the compression molding die 30, a pressure P of 300 MPa was applied to the sample Sa using the upper punch 31 and the lower punch 33.

While the pressure P was being applied to the sample Sa, the upper punch 31 and the lower punch 33 were connected to a potentiostat 50 equipped with a frequency response analyzer. VersaSTAT4 manufactured by Princeton Applied Research was used as the potentiostat 50. The upper punch 31 was connected to a working electrode and a potential measuring terminal of the potentiostat 50. The lower punch 33 was connected to a counter electrode and a reference electrode of the potentiostat 50. An impedance of the sample Sa was measured at room temperature (25° C.) by an electrochemical impedance measurement method. A relative permittivity ε′ᵣ of the halide included in the dielectric according to Example 1 at 1 MHz was measured in this manner. A capacitance of the sample was measured, and the measurement value of the capacitance, a thickness of the sample Sa, and an electrode area were used to determine the relative permittivity ε′ᵣ. The relative permittivity ε′ᵣ measured was corrected using a fill rate f of the pellet (the sample Sa compacted by the pressure P) by the following formula to determine a relative permittivity Er. In the following formula, ε_{Air} is a relative permittivity of air, and was defined as 1 for this calculation.

$$log {ε}_{r} = ( log {ε}_{r}^{′} - {( 1 - f )}^{*} log {ε}_{Air} ) / f$$

The fill rate f was calculated by the following formula. The symbol ρₚₑₗₗₑₜ is a density of the pellet, and p is a density determined from a crystal structure. Table 1 shows the result. As shown in Table 1, the relative permittivity Er of the halide included in the dielectric according to Example 1 at 25° C. is 119.

$$f = {ρ}_{pellet} / ρ$$

### (Evaluation of Polarization)

A calculation value of a polarization P of the dielectric according to Example 1was calculated by the following formula (1) on the basis of the relative permittivity εᵣ determined by the above evaluation of the relative permittivity. Table 1 shows the result. In the formula (1), ε₀ is a permittivity in vacuum, and E is a breakdown electric field. The breakdown electric field E was calculated by the following formula (2) with reference to Wang, Li-Mo. “Relationship between intrinsic breakdown field and bandgap of materials.” 2006 25th International Conference on Microelectronics. IEEE, 2006. In the formula (2), E_{g} is a band gap, and is assumed to be 4 eV for this calculation. The units of E and E_{g} in the formulae (1) and (2) are respectively V/cm and eV.

$$P = {ε}_{0} ( {ε}_{r} - 1 ) E \qquad Formula ( 1 )$$

$$E = 1.36 \times {10}^{7} \times ( {E}_{g} / 4 ) \qquad Formula ( 2 )$$

### (Crystal Structure Analysis)

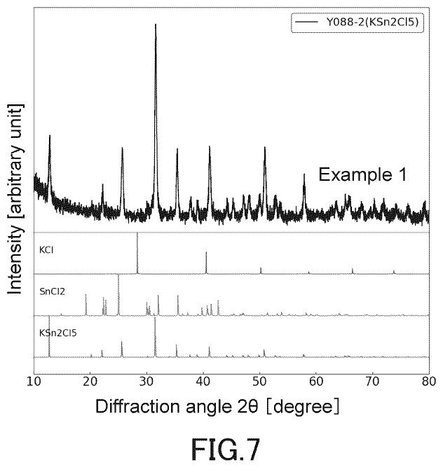

X-ray diffraction (XRD) measurement was performed to identify the crystal structure of the dielectric according to Example 1. This measurement was performed under a dry argon atmosphere using a Cu-Kα ray as an X-ray. FIG. 7 is a graph showing an XRD pattern of the dielectric according to Example 1. The horizontal axis indicates a diffraction angle 2θ, and the vertical axis indicates an intensity of X-ray diffraction. FIG. 7 also shows calculation results for XRD patterns of KCI, SnCl₂, and KSn₂Cl₅ which is of a (NH₄)Pb₂Br₅ type. Note that the vertical axis in FIG. 7 shows a relative relation of a diffraction intensity in each XRD pattern, and does not show a relative relation of diffraction intensities between the different XRD patterns. The XRD pattern of the dielectric according to Example 1 suggests that the dielectric according to Example 1 has a (NH₄)Pb₂Br₅-type crystal structure.

### <Example 2>

A powdery dielectric according to Example 2 was produced in the same manner as in Example 1, except that a raw material powder including KBr and SnCl₂ was prepared such that a ratio of the amount of substance of KBr to the amount of substance of SnCl₂ was 1:2. The composition of the dielectric according to Example 2 was determined by the XPS measurement in the same manner as in Example 1. Moreover, the relative permittivity and the polarization were evaluated for the dielectric according to Example 2 in the same manner as in Example 1. Table 1 shows the results.

### <Example 3>

A powdery dielectric according to Example 3 was produced in the same manner as in Example 1, except that a raw material powder including KBr and SnBr2 was prepared such that a ratio of the amount of substance of KBr to the amount of substance of SnBr₂ was 1:2. The composition of the dielectric according to Example 3 was determined by the XPS measurement in the same manner as in Example 1. Moreover, the relative permittivity and the polarization were evaluated for the dielectric according to Example 3 in the same manner as in Example 1. Table 1 shows the results.

### <Example 4>

A powdery dielectric according to Example 4 was produced in the same manner as in Example 1, except that a raw material powder including K (SCN) and SnCl₂ was prepared such that a ratio of the amount of substance of K (SCN) to the amount of substance of SnCl₂ was 1:2. SCN-is a negative monovalent cluster anion, and was considered as one anion. The composition of the dielectric according to Example 4 was determined by the XPS measurement in the same manner as in Example 1. Moreover, the relative permittivity and the polarization were evaluated for the dielectric according to Example 4 in the same manner as in Example 1. Table 1 shows the results.

### <Example 5>

A powdery dielectric according to Example 5 was produced in the same manner as in Example 1, except that a raw material powder including KCl and SnBr₂ was prepared such that a ratio of the amount of substance of KCl to the amount of substance of SnBr₂ was 1:2. The composition of the dielectric according to Example 5 was determined by the XPS measurement in the same manner as in Example 1. Moreover, the relative permittivity and the polarization were evaluated for the dielectric according to Example 5 in the same manner as in Example 1. Table 1 shows the results.

<Example 6>

A powdery dielectric according to Example 6 was produced in the same manner as in Example 1, except that a raw material powder including Kl and SnCl₂ was prepared such that a ratio of the amount of substance of KI to the amount of substance of SnCl₂ was 1:2. The composition of the dielectric according to Example 6 was determined by the XPS measurement in the same manner as in Example 1. Moreover, the relative permittivity and the polarization were evaluated for the dielectric according to Example 6in the same manner as in Example 1. Table 1 shows the results.

### <Example 7>

A powdery dielectric according to Example 7 was produced in the same manner as in Example 1, except that a raw material powder including KCl and PbCl₂ such that a ratio of the amount of substance of KCI to the amount of substance of PbCl₂ was 1:2. The composition of the dielectric according to Example 7 was determined by the XPS measurement in the same manner as in Example 1. Moreover, the relative permittivity and the polarization were evaluated for the dielectric according to Example 7 in the same manner as in Example 1. Table 1 shows the results.

### <Example 8>

A powdery dielectric according to Example 8 was produced in the same manner as in Example 1, except that a raw material powder including KF, KCl, and SnCl₂ was prepared such that a ratio of the amount of substance of KF to the amount of substance of KCI to the amount of substance of SnCl₂ was 0.5:0.5:2. The composition of the dielectric according to Example 8 was determined by the XPS measurement in the same manner as in Example 1. Moreover, the relative permittivity and the polarization were evaluated for the dielectric according to Example 8 in the same manner as in Example 1. Table 1 shows the results.

### <Example 9>

A powdery dielectric according to Example 9 was produced in the same manner as in Example 1, except that a raw material powder including KF, KCl, and PbCl₂ was prepared such that a ratio of the amount of substance of KF to the amount of substance of KCI to the amount of substance of PbCl₂ was 0.5:0.5:2. The composition of the dielectric according to Example 9 was determined by the XPS measurement in the same manner as in Example 1. Moreover, the relative permittivity and the polarization were evaluated for the dielectric according to Example 9 in the same manner as in Example 1. Table 1 shows the results.

### <Example 10>

A powdery dielectric according to Example 10 was produced in the same manner as in Example 1, except that a raw material powder including Kl and Snl₂ was prepared such that a ratio of the amount of substance of KI to the amount of substance of Snl2 was 1:2. The composition of the dielectric according to Example 10 was determined by the XPS measurement in the same manner as in Example 1. Moreover, the relative permittivity and the polarization were evaluated for the dielectric according to Example 10 in the same manner as in Example 1. Table 1 shows the results.

### <Example 11>

A powdery dielectric according to Example 11 was produced in the same manner as in Example 1, except that a raw material powder including KCl, SnCl₂, and PbCl₂ was prepared such that a ratio of the amount of substance of KCl to the amount of substance of SnCl₂ to the amount of substance of PbCl₂ was 1:1:1. The composition of the dielectric according to Example 11 was determined by the XPS measurement in the same manner as in Example 1. Moreover, the relative permittivity and the polarization were evaluated for the dielectric according to Example 11 in the same manner as in Example 1. Table 1 shows the results.

### <Example 12>

A powdery dielectric according to Example 12 was produced in the same manner as in Example 1, except that a raw material powder including NaF and SnF₂ was prepared such that a ratio of the amount of substance of NaF to the amount of substance of SnF2 was 1:2. The composition of the dielectric according to Example 12 was determined by the XPS measurement in the same manner as in Example 1. Moreover, the relative permittivity and the polarization were evaluated for the dielectric according to Example 12 in the same manner as in Example 1. Table 1 shows the results.

### <Example 13>

A powdery dielectric according to Example 13 was produced in the same manner as in Example 1, except that a raw material powder including RbCl and PbCl₂ was prepared such that a ratio of the amount of substance of RbCI to the amount of substance of PbCl2 was 1:2. The composition of the dielectric according to Example 13 was determined by the XPS measurement in the same manner as in Example 1. Moreover, the relative permittivity and the polarization were evaluated for the dielectric according to Example 13 in the same manner as in Example 1. Table 1 shows the results.

### <Example 14>

A powdery dielectric according to Example 14 was produced in the same manner as in Example 1, except that a raw material powder including RbCl and SnCl₂ was prepared such that a ratio of the amount of substance of RbCl to the amount of substance of SnCl₂ was 1:2. The composition of the dielectric according to Example 14 was determined by the XPS measurement in the same manner as in Example 1. Moreover, the relative permittivity and the polarization were evaluated for the dielectric according to

Example 14 in the same manner as in Example 1. Table 1 shows the results.

### <Example 15>

A powdery dielectric according to Example 15 was produced in the same manner as in Example 1, except that a raw material powder including CsCI and PbCl₂ was prepared such that a ratio of the amount of substance of CsCI to the amount of substance of PbCl₂ was 1:2.5. The composition of the dielectric according to Example 15 was determined by the XPS measurement in the same manner as in Example 1. Moreover, the relative permittivity and the polarization were evaluated for the dielectric according to Example 15 in the same manner as in Example 1. Table 1 shows the results.

### <Example 16>

A powdery dielectric according to Example 16 was produced in the same manner as in Example 1, except that a raw material powder including CsCl and PbCl₂ was prepared such that a ratio of the amount of substance of CsCI to the amount of substance of PbCl₂ was 1:2. The composition of the dielectric according to Example 16 was determined by the XPS measurement in the same manner as in Example 1. Moreover, the relative permittivity and the polarization were evaluated for the dielectric according to Example 16 in the same manner as in Example 1. Table 1 shows the results.

### <Example 17>

A powdery dielectric according to Example 17 was produced in the same manner as in Example 1, except that a raw material powder including CsBr and SnCl₂ was prepared such that a ratio of the amount of substance of CsBr to the amount of substance of SnCl₂ was 1:2. The composition of the dielectric according to Example 17 was determined by the XPS measurement in the same manner as in Example 1. Moreover, the relative permittivity and the polarization were evaluated for the dielectric according to Example 17 in the same manner as in Example 1. Table 1 shows the results.

### <Example 18>

A powdery dielectric according to Example 18 was produced in the same manner as in Example 1, except that a raw material powder including CsCI and SnCl₂ was prepared such that a ratio of the amount of substance of CsCI to the amount of substance of SnCl₂ was 1:2. The composition of the dielectric according to Example 18 was determined by the XPS measurement in the same manner as in Example 1. Moreover, the relative permittivity and the polarization were evaluated for the dielectric according to Example 18 in the same manner as in Example 1. Table 1 shows the results.

### <Example 19>

A powdery dielectric according to Example 19 was produced in the same manner as in Example 1, except that a raw material powder including Inl and SnCl₂ was prepared such that a ratio of the amount of substance of Inl to the amount of substance of SnCl₂ was 1:2. The composition of the dielectric according to Example 19 was determined by the XPS measurement in the same manner as in Example 1. Moreover, the relative permittivity and the polarization were evaluated for the dielectric according to Example 19 in the same manner as in Example 1. Table 1 shows the results.

### <Example 20>

A powdery dielectric according to Example 20 was produced in the same manner as in Example 1, except that a raw material powder including Inl and Snl₂ was prepared such that a ratio of the amount of substance of Inl to the amount of substance of Snl₂ was 1:2. The composition of the dielectric according to Example 20 was determined by the XPS measurement in the same manner as in Example 1. Moreover, the relative permittivity and the polarization were evaluated for the dielectric according to Example 20 in the same manner as in Example 1. Table 1 shows the results.

### <Comparative Example 1>

A powdery dielectric according to Comparative Example 1 was produced in the same manner as in Example 1, except that a raw material powder including CsCl and PbCl₂ was prepared such that a ratio of the amount of substance of CsCI to the amount of substance of PbCl₂ was 1:1. The composition of the dielectric according to Comparative Example 1 was determined by the XPS measurement in the same manner as in Example 1. Moreover, the relative permittivity and the polarization were evaluated for the dielectric according to Comparative Example 1 in the same manner as in Example 1. Table 1 shows the results.

### <Comparative Example 2>

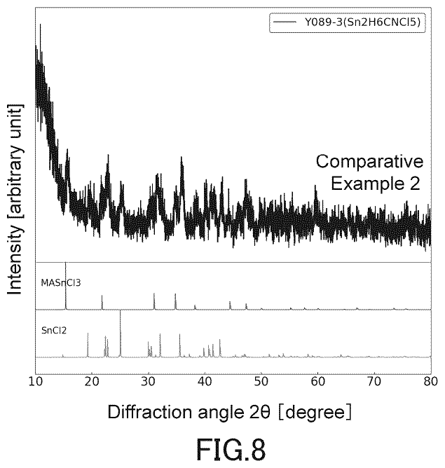

A powdery dielectric according to Comparative Example 2 was produced in the same manner as in Example 1, except that a raw material powder including (CH₃NH₃) Cl and SnCl₂ was prepared such that a ratio of the amount of substance of (CH₃NH₃) Cl to the amount of substance of SnCl₂ was 1:1. The composition of the dielectric according to Comparative Example 2 was determined by the XPS measurement in the same manner as in Example 1. The relative permittivity and the polarization were evaluated for the dielectric according to Comparative Example 2 in the same manner as in Example 1. Table 1 shows the results. Additionally, the crystal structure analysis was performed for the dielectric according to Comparative Example 2 in the same manner as in Example 1. FIG. 8 is a graph showing an XRD pattern of the dielectric according to Comparative

Example 2. The horizontal axis indicates a diffraction angle 20, and the vertical axis indicates an intensity of X-ray diffraction. FIG. 8 also shows calculation results for XRD patterns of MASnCls of perovskite type and SnCl₂. MA in MASnCls is a methylamine ion (CH₃NH₃) +. Note that the vertical axis in FIG. 8 shows a relative relation of a diffraction intensity in each XRD pattern, and does not show a relative relation of diffraction intensities between the different XRD patterns. The XRD pattern of the dielectric according to Comparative Example 2 suggests that the dielectric according to Comparative Example 2 has a perovskite-type crystal structure.

### <Comparative Example 3>

A powdery dielectric according to Comparative Example 3 was produced in the same manner as in Example 1, except that a raw material powder including BaF₂ and MgF₂ was prepared such that a ratio of the amount of substance of BaF₂ to the amount of substance of MgF₂ was 1:1. The composition of the dielectric according to Comparative Example 3 was determined by the XPS measurement in the same manner as in Example 1. Moreover, the relative permittivity and the polarization were evaluated for the dielectric according to Comparative Example 3 in the same manner as in Example 1.Table 1 shows the results.

As for the dielectrics according to Example 1 to Example 20, the ratio r of the number of cations to the number of anions satisfies the requirement 1/2<r<2/3 as shown in Table 1, and the dielectric according to each Example has a relative permittivity more than 40. On the other hand, the dielectrics according to Comparative Examples 1 and 2 in which the ratio r is 2/3 have a relative permittivity less than 40.0 at a frequency of 1 MHz. The dielectric according to Comparative Example 3 in which the ratio r is 1/2 also has a low relative permittivity, namely, less than 40, at a frequency of 1 MHZ. Therefore, the calculation values of polarization of the dielectrics according to Example 1 to Example 20 are higher than those of the dielectrics according to Comparative Examples 1 to 3. These indicate that a dielectric that includes a halide and in which the ratio r of the number of cations to the number of anions satisfies the requirement 1/2<r <2/3 is likely to have a high relative permittivity.

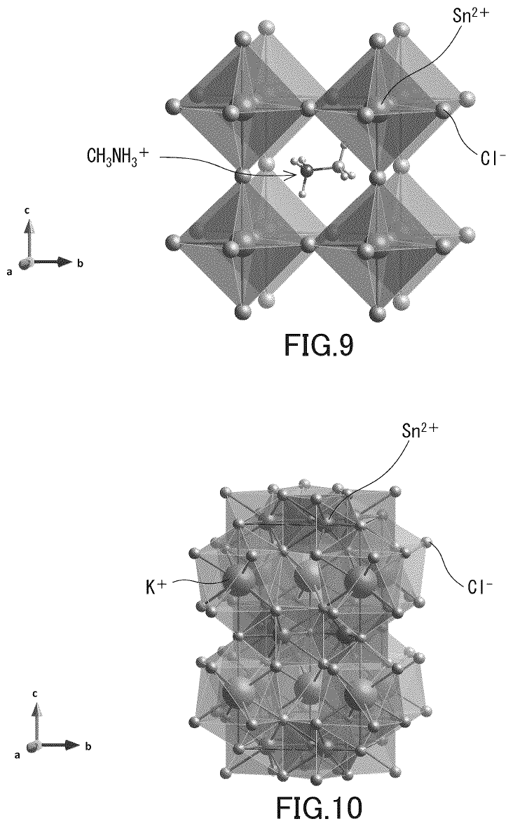

FIGS. 7 and 8 indicate that the dielectric according to Example 1 has a (NH₄)Pb₂Br₅-type crystal structure and the dielectric according to Comparative Example 2 has a perovskite-type crystal structure. FIG. 9 shows a perovskite-type crystal structure of (CH₃NH₃SnCl₃. FIG. 10 shows a (NH₄)Pb₂Br₅-type crystal structure of KSn₂Cl₅. As shown in FIG. 9, in the crystal structure of (CH₃NH₃)SnCl₃, the coordination number of Cl⁻ around Sn²⁺ is six. On the other hand, as shown in FIG. 10, in the crystal structure of KSn₂Cl₅ which is of a (NH₄)Pb₂Br₅ type, the coordination number of Cl⁻ around Sn²⁺ is eight. As described above, a ratio of the coordination number of the anion to that of the cation in the dielectric according to Example 1 is larger than that in the dielectric according to Comparative Example 2. This is thought to be one reason why the relative permittivity of the dielectric according to Example 1 is higher than that of the dielectric according to Comparative Example 2. When the ratio r of the number of cations to the number of anions in the halide satisfies the requirement 1/2<r<2/3 in the dielectric, it is likely that the coordination number of the anion to that of the cation is large and the dielectric has a high relative permittivity.

TABLE 1

| | | | Measurement value of | Calculation value |
|---|---|---|---|---|
| | | Number of cation/ | relative permittivity | of polarization |
| | Composition | number of anion | 25° C., 1 MHz | [mC/cm²] |
| Example 1 | KSn₂Cl₅ | 0.60 | 119 | 97.9 |
| Example 2 | KSn₂Br₄Cl | 0.60 | 184 | 151.8 |
| Example 3 | KSn₂Br₅ | 0.60 | 50.4 | 41.0 |
| Example 4 | KSn₂Cl₄(SCN) | 0.60 | 84 | 68.8 |
| Example 5 | KSn₂Cl₄Br | 0.60 | 104 | 85.4 |
| Example 6 | KSn₂Cl₄I | 0.60 | 45.2 | 36.7 |
| Example 7 | KPb₂Cl₅ | 0.60 | 50.3 | 40.9 |
| Example 8 | KSn₂F_{0.5}Cl_{4.5} | 0.60 | 162 | 133.5 |
| Example 9 | KPb₂F_{0.5}Cl_{4.5} | 0.60 | 46.4 | 37.7 |
| Example 10 | KSn₂I₅ | 0.60 | 132 | 108.7 |
| Example 11 | KSnPbCl₅ | 0.60 | 156 | 128.6 |
| Example 12 | NaSn₂F₅ | 0.60 | 52 | 42.3 |
| Example 13 | RbPb₂Cl₅ | 0.60 | 49.6 | 40.3 |
| Example 14 | RbSn₂Cl₅ | 0.60 | 69.3 | 56.7 |
| Example 15 | CsPb_{2.5}Cl₆ | 0.58 | 50.1 | 40.7 |
| Example 16 | CsPb₂Cl₅ | 0.60 | 65.3 | 53.3 |
| Example 17 | CsSn₂Cl₄Br | 0.60 | 66 | 53.9 |
| Example 18 | CsSn₂Cl₅ | 0.60 | 51.7 | 42.1 |
| Example 19 | InSn₂Cl₄I | 0.60 | 53.5 | 43.5 |
| Example 20 | InSn₂I₅ | 0.60 | 300 | 248.0 |
| Comparative | CsPbCl₃ | 0.67 | 39.6 | 32 |
| Example1 | | | | |
| Comparative | (CH₃NH₃)SnCl₃ | 0.67 | 22.3 | 17.7 |
| Example 2 | | | | |
| Comparative | BaMgF₄ | 0.5 | 17.4 | 13.6 |
| Example 3 | | | | |

### INDUSTRIAL APPLICABILITY

The capacitor according to the present disclosure is likely to have a high capacitance and is thus useful.

What is claimed is:

1. A capacitor comprising
a first electrode;
a second electrode; and
a dielectric disposed between the first electrode and the second electrode, wherein
the dielectric includes a halide and satisfies a requirement 1/2<r<2/3, where r is a ratio of the number of cations to the number of anions in the halide.

2. The capacitor according to claim 1, wherein the dielectric satisfies a requirement 0.57≤r≤0.61.

3. The capacitor according to claim 1, wherein the cation includes an ion of an element in at least one group selected from the group consisting of Group 13, Group 14,and Group 15.

4. The capacitor according to claim 3, wherein the cation has a lone pair.

5. The capacitor according to claim 1, wherein the cation includes at least one selected from the group consisting of Int, Tl⁺, Ge²⁺, Sn²⁺, Pb²⁺, Sb³⁺, and Bi³⁺.

6. The capacitor according to claim 1, wherein the cation includes at least one selected from the group consisting of Li⁺, Na⁺, K⁺, Rb⁺, Cs⁺, In⁺, and Tl⁺.

7. The capacitor according to claim 1, wherein
the dielectric has a composition represented by AB₂X₅, where
A is at least one selected from the group consisting of Li⁺, Na⁺, K⁺, Rb⁺, Cs⁺, In⁺, and Tl⁺,
B is at least one selected from the group consisting of Sn²⁺ and Pb²⁺, and
X is at least one selected from the group consisting of F⁻, Cl⁻, Br, I⁻, and SCN⁻.

8. The capacitor according to claim 1, wherein the anion is at least one selected from the group consisting of F⁻ and Cl⁻.

9. An electrical circuit comprising the capacitor according to claim 1.

10. A circuit board comprising the capacitor according to claim 1.

11. An apparatus comprising the capacitor according to claim 1.
